(19) United States
(12) Patent Application Publication
(10) Pub. No.: US 2024/0303855 A1
(43) Pub. Date: Sep. 12, 2024

(54) POSTURE ESTIMATION APPARATUS, LEARNING MODEL GENERATION APPARATUS, POSTURE ESTIMATION METHOD, LEARNING MODEL GENERATION METHOD, AND COMPUTER-READABLE RECORDING MEDIUM

(71) Applicant: NEC CORPORATION, Tokyo (JP)

(72) Inventor: Yadong PAN, Tokyo (JP)

(73) Assignee: NEC CORPORATION, Tokyo (JP)

(21) Appl. No.: 18/271,377

(22) PCT Filed: Jan. 15, 2021
(86) PCT No.: PCT/JP2021/001248

§ 371 Date: Jul. 7, 2023

(51) Int. Cl. G06T 7/73

(52) U.S. Cl. CPC G06T 7/73; G06T 2207/20044; G06T 2207/30196

(57) ABSTRACT

The posture estimation apparatus includes a joint point detection unit that detects joint points of a person in an image, a reference point specifying unit that specifies a preset reference point for each person, an attribution determination unit uses a learning model that machine-learns the relationship between a pixel data and the unit vector of the vector starting from a pixel to the reference point, to obtain a relationship between the detected joint points and the reference point of the each person in the image for each detected joint point, and to calculate a score indicating the possibility that the joint point belongs to the person, to determine the person in the image to which the joint point belongs by using the score, a posture estimation unit that estimates the posture of the person based on the result of determination by the attribution determination unit.

### TECHNICAL FIELD

The present invention relates to a posture estimation apparatus and a posture estimation method for estimating the posture of a person in an image, and further relates to a computer-readable recording medium in which is recorded a program for realizing the same. And then, the present invention relates also to a learning model generation apparatus and a learning model generation method for generating a learning model used for the posture estimation apparatus and a posture estimation method, and further relates to a computer-readable recording medium in which is recorded a program for realizing the same.

### BACKGROUND ART

In recent years, research on estimating the posture of a person from an image has attracted attention. Such research is expected to be used in the fields of image surveillance and sports. Further, by estimating the posture of a person from an image, for example, the movement of a clerk in a store can be analyzed, and it is considered that it can contribute to efficient product placement.

Non-Patent Document 1 discloses an example of a system for estimating the posture of a person. The system disclosed in Non-Patent Document 1 first acquires image data output from a camera and detects an image of a person from the image displayed by the acquired image data. Next, the system disclosed in Non-Patent Document 1 further detects a joint point in the image of the detected person.

Next, as shown in FIG. 13, the system disclosed in Non-Patent Document 1 calculates a vector from the center point of the person to the joint point for each joint point. And the system disclosed in Non-Patent Document 1 applies each of the calculated vector to a learning model. The learning model is constructed by performing machine learning using a group of vectors to which labels indicating postures are given in advance as training data. As a result, the posture is output from the learning model according to the applied vector, and the system disclosed in Patent Document 1 uses the output posture as the estimation result.

### LIST OF RELATED ART DOCUMENT

### Patent Document

Non Patent Document 1: Nie, Xuecheng et al. “Single-Stage Multi-Person Pose Machines.”, 2019 IEEE/CVF International Conference on Computer Vision (ICCV 2019)

### SUMMARY OF INVENTION

### Problems to be Solved by the Invention

By the way, each vector used as training data is composed of a direction and a length. However, since the length of the vector varies from person to person and varies widely, it is difficult to construct an appropriate learning model with such training data. Therefore, the system disclosed in Non-Patent Document 1 has a problem that it is difficult to improve the posture estimation accuracy.

An example of an object of the present invention is to provide a posture estimation apparatus, a posture estimation method, a learning model generation apparatus, a learning model generation method, and a computer-readable recording medium capable of improving the estimation accuracy when estimating the posture of a person from an image.

### Means for Solving the Problems

To achieve the above-described object, a posture estimation apparatus according to one aspect of the present invention is an apparatus, including:
a joint point detection unit configured to detect joint points of a person in an image,
a reference point specifying unit configured to specify a preset reference point for each person in the image,
an attribution determination unit configured to use a learning model that machine-learns the relationship between a pixel data and the unit vector of the vector starting from a pixel to the reference point for each pixel in the segmentation region of the person, to obtain a relationship between the detected joint points and the reference point of the each person in the image for each detected joint point, and then to calculate a score indicating the possibility that the joint point belongs to the person in the image based on the obtained relationship, to determine the person in the image to which the joint point belongs by using the calculated score,
a posture estimation unit configured to estimate the posture of the person in the image based on the result of determination by the attribution determination unit.

To achieve the above-described object, a learning model generation apparatus according to one aspect of the present invention is an apparatus, including:
a learning model generation unit configured to use pixel data for each pixel of the segmentation region of a person, coordinates date for each pixel of the segmentation region, and a unit vector of the vector starting from a pixel to a preset reference point for each pixel of the segmentation region as training data, to perform machine learning to generate a learning model.

To achieve the above-described object, a posture estimation method according to one aspect of the present invention is a method, including:
a joint point detection step of detecting joint points of a person in an image,
a reference point specifying step of specifying a preset reference point for each person in the image,
an attribution determination step of using a learning model that machine-learns the relationship between a pixel data and the unit vector of the vector starting from a pixel to the reference point for each pixel in the segmentation region of the person, to obtain a relationship between the detected joint points and the reference point of the each person in the image for each detected joint point, and then calculating a score indicating the possibility that the joint point belongs to the person in the image based on the obtained relationship, determining the person in the image to which the joint point belongs by using the calculated score,
a posture estimation step of estimating the posture of the person in the image based on the result of determination by the attribution determination step.

To achieve the above-described object, a learning model generation method according to one aspect of the present invention is a method, including:
a learning model generation step of using pixel data for each pixel of the segmentation region of a person, coordinates date for each pixel of the segmentation region, and a unit vector of the vector starting from a pixel to a preset reference point for each pixel of the segmentation region as training data, to perform machine learning to generate a learning model.

Furthermore, a first computer-readable recording medium according to one aspect of the present invention is a computer-readable recording medium that includes a program recorded thereon, the program including instructions that cause the computer to carry out:
a joint point detection step of detecting joint points of a person in an image, a reference point specifying step of specifying a preset reference point for each person in the image,
an attribution determination step of using a learning model that machine-learns the relationship between a pixel data and the unit vector of the vector starting from a pixel to the reference point for each pixel in the segmentation region of the person, to obtain a relationship between the detected joint points and the reference point of the each person in the image for each detected joint point, and then calculating a score indicating the possibility that the joint point belongs to the person in the image based on the obtained relationship, determining the person in the image to which the joint point belongs by using the calculated score,
a posture estimation step of estimating the posture of the person in the image based on the result of determination by the attribution determination step.

Furthermore, a second computer-readable recording medium according to one aspect of the present invention is a computer-readable recording medium that includes a program recorded thereon, the program including instructions that cause the computer to carry out:
a learning model generation step of using pixel data for each pixel of the segmentation region of a person, coordinates date for each pixel of the segmentation region, and a unit vector of the vector starting from a pixel to a preset reference point for each pixel of the segmentation region as training data, to perform machine learning to generate a learning model.

### Advantageous Effects of the Invention

As described above, according to the present invention, it is possible to improve the estimation accuracy when estimating the posture of a person from an image.

### BRIEF DESCRIPTION OF THE DRAWINGS

FIG. 1 is a block diagram showing an overall configuration of a learning model generation apparatus according to a first example embodiment.

FIG. 2 is a block diagram showing a specific configuration of the learning model generation apparatus according to the first example embodiment.

FIG. 3 is a diagram illustrating a unit vector used in the first example embodiment.

FIG. 4 is a diagram (direction map) showing the x component and the y component of the unit vector extracted from the image of a person.

FIG. 5 is a flowchart showing operations of the learning model generation apparatus according to the first example embodiment.

FIG. 6 is a block diagram showing an overall configuration of a posture estimation apparatus according to a second example embodiment.

FIG. 7 is a block diagram showing a specific configuration of the posture estimation apparatus according to the second example embodiment.

FIG. 8 is a diagram illustrating the attribution determination process of the posture estimation apparatus according to the second example embodiment.

FIG. 9 is a diagram illustrating a score calculated by the attribution determination process shown in FIG. 8.

FIG. 10 is a diagram illustrating a correction process after the attribution determination of the posture estimation apparatus according to the second example embodiment.

FIG. 11 is a flowchart showing operations of the posture estimation apparatus according to the second example embodiment.

FIG. 12 is a block diagram showing an example of a computer that realizes the learning model generation apparatus according to the first example embodiment and the posture estimation apparatus according to the second example embodiment.

FIG. 13 is a diagram illustrating posture estimation of a person by a conventional system.

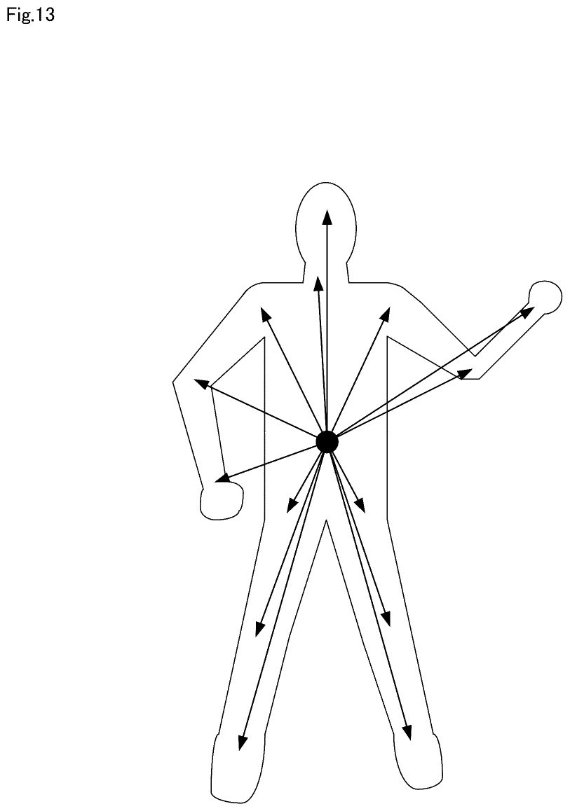

### EXAMPLE EMBODIMENT

### First Example Embodiment

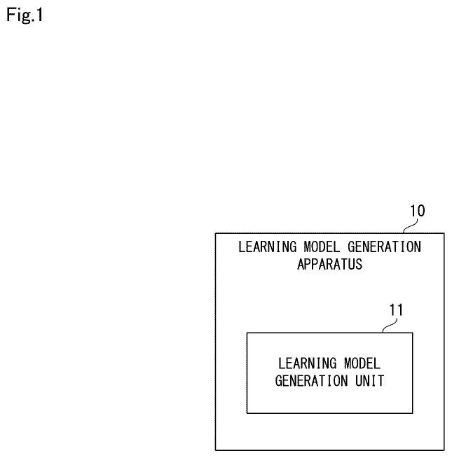

The following describes a learning model generation apparatus, a learning model generation method, and a program for generating the learning model according to a first example embodiment with reference to FIGS. 1 to 5.

### Apparatus Configuration

First, an overall configuration of a learning model generation apparatus according to a first example embodiment will be described with reference to FIG. 1. FIG. 1 is a block diagram showing an overall configuration of a learning model generation apparatus according to a first example embodiment.

A learning model generation apparatus 10 according to the first example embodiment shown in FIG. 1 is an apparatus that generates a learning model used for estimating the posture of a person. As shown in FIG. 1, the learning model generation apparatus 10 includes a learning model generation unit 11.

The learning model generation unit acquires training data, perform machine learning using the acquired training data, and generating a learning model. As the training data, pixel data for each pixel of the segmentation region of a person, coordinates date for each pixel of the segmentation region, and a unit vector for each pixel in the segmentation region. The unit vector is a unit vector of a vector starting from each pixel and up to a preset reference point.

According to the learning model generation apparatus 10, a learning model is obtained in which the relationship between the pixel data and the unit vector is machine-learned for each pixel in the segmentation region of the person. Then, if the pixel data of the image of the joint point of the person in the image is input to the learning model, the unit vector at the joint point is output. By using the output unit vector, it is possible to estimate the posture of the person in the image as described in the second example embodiment.

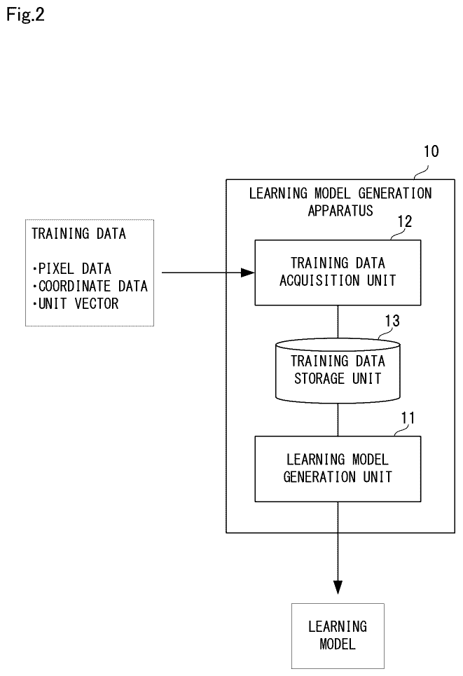

Next, the configuration and the functions of the learning model generation apparatus 10 according to the first example embodiment will be specifically described with reference to FIG. 2. FIG. 2 is a block diagram showing a specific configuration of the learning model generation apparatus according to the first example embodiment.

As shown in FIG. 2, in the first example embodiment, the learning model generation apparatus 10 includes a training data acquisition unit 12 and a training data storage unit 13 in addition to the learning model generation unit 11.

The training data acquisition unit 12 receives training data input from the outside of the learning model generation apparatus 10 and stores the received training data in the training data storage unit 13. In the first example embodiment, the learning model generation unit 11 executes machine learning using the training data stored in the training data storage unit 13 to generate a learning model. The learning model generation unit 11 outputs the generated learning model to a posture estimation apparatus described later.

Further, examples of the machine learning method used by the learning model generation unit 11 include zero-shot learning, deep learning, ridge regression, logistic regression, support vector machine, and gradient boosting.

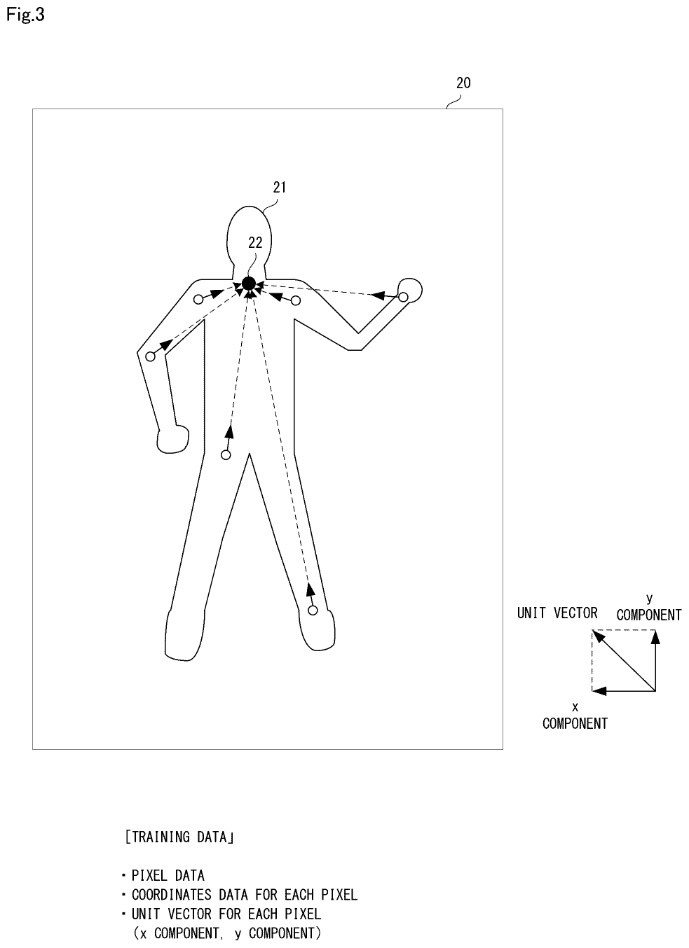

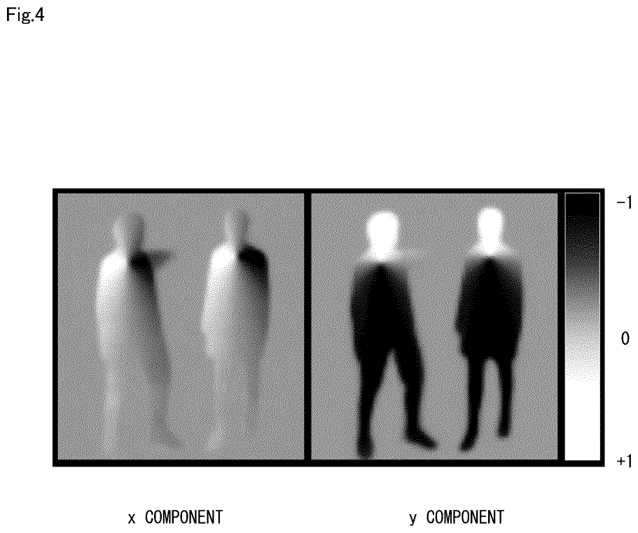

Further, the training data used in the first example embodiment will be specifically described with reference to FIGS. 3 and 4. FIG. 3 is a diagram illustrating a unit vector used in the first example embodiment. FIG. 4 is a diagram (direction map) showing the x component and the y component of the unit vector extracted from the image of a person.

In the first example embodiment, the training data is generated in advance from the image data of a person's image by an image processing device or the like. Specifically, as shown in FIG. 3, first, the segmentation region 21 of the person in the image is extracted from the image data 20. Next, a reference point 22 is set in the segmentation region 21. Examples of the area where the reference point 22 is set include the area of the trunk of the person or the area of the neck. In the example of FIG. 3, the reference point 22 is set in the neck region. In addition, the reference point is set according to a preset rule. As the rule, for example, it is set at the point where the perpendicular line passing through the apex of the nose and the horizontal line passing through the throat intersect.

After that, the coordinate data of each pixel is specified, a vector up to a reference point starting from the coordinate data is calculated for each pixel, and a unit vector is calculated for each of the calculated vectors. In the example of FIG. 3, “circle mark” indicates an arbitrary pixel, the dashed arrow indicates a vector from an arbitrary pixel to the reference point 22, and the practical arrow indicates a unit vector. Further, the unit vector is a vector having a magnitude of “1” and is composed of an x component and a y component.

The pixel data for each pixel, the coordinate data for each pixel, and the unit vector (x component, y component) for each pixel obtained in this way are used as training data. When the unit vector for each pixel is mapped, it becomes as shown in FIG. 4. The map shown in FIG. 4 is obtained from an image in which two people are present.

### Apparatus Operations

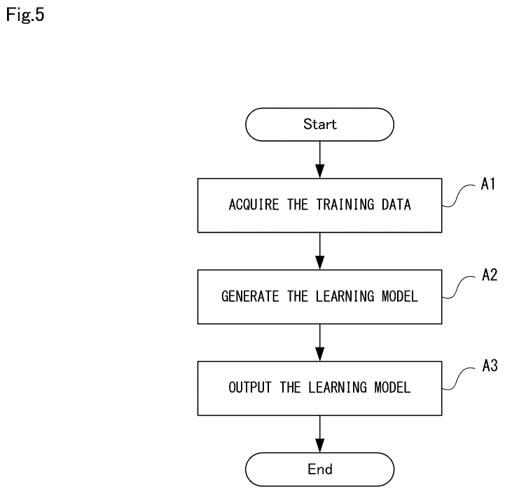

Next, operations of the learning model generation apparatus 10 according to the first example embodiment will be described with reference to FIG. 5. FIG. 5 is a flowchart showing operations of the learning model generation apparatus according to the first example embodiment. In the following description, FIGS. 1 to 4 are referenced when necessary. Also, in the first example embodiment, a learning model generation method is carried out by operating the learning model generation apparatus 10. Therefore, the following description of operations of the learning model generation apparatus 10 substitutes for a description of the learning model generation method in the first example embodiment.

As shown in FIG. 5, first, the training data acquisition unit 12 receives the training data input from the outside of the learning model generation apparatus 10 and stores the received training data in the training data storage unit 13 (step A1). The training data received in step A1 is composed of pixel data for each pixel, coordinate data for each pixel, and a unit vector (x component, y component) for each pixel.

Next, the learning model generation unit 11 executes machine learning using the training data stored in the training data storage unit 13 in step A1 to generate a learning model (step A2). Further, the learning model generation unit 11 outputs the learning model generated in step A2 to the posture estimation apparatus described later (step A3).

By executing steps A1 to A3, the learning model is obtained in which the relationship between the pixel data and the unit vector is machine-learned for each pixel in the segmentation region of the person.

### Program

A program for generating the learning model according to the first example embodiment may be a program that enables a computer to execute the steps A1 to A3 shown in FIG. 5. It is possible to realize the learning model generation apparatus 10 and the learning model generation method according to the first example embodiment by installing this program to a computer and executing the program. In this case, a processor of the computer functions as the learning model generation unit 11 and the training data acquisition unit 12 and performs processing. Example of computer includes smartphone and tablet-type terminal device in addition to general-purpose personal computer.

Further, in the first example embodiment, the training data storage unit 13 may be realized by storing the data files constituting them in a storage device such as a hard disk provided in the computer. And then, the training data storage unit 13 may be realized by a storage device of another computer.

The program according to the first example embodiment may also be executed by a computer system built from a plurality of computers. In this case, for example, each computer may function as the learning model generation unit 11 and the training data acquisition unit 12.

### Second Example Embodiment

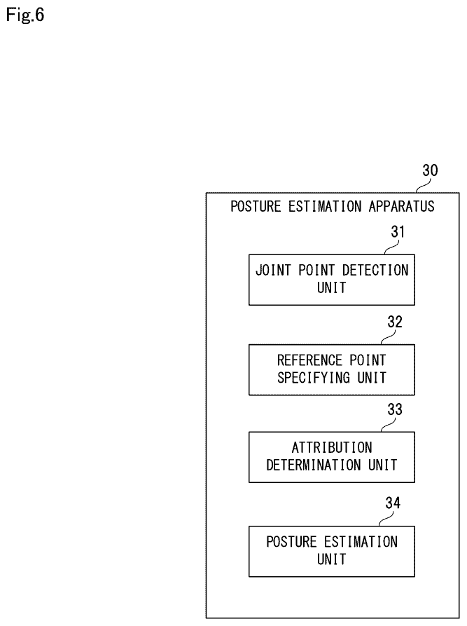

The following describes a posture estimation apparatus, a posture estimation method, and a program for estimating the posture according to a second example embodiment with reference to FIGS. 6 to 11.

### Apparatus Configuration

First, an overall configuration of a posture estimation apparatus according to a second example embodiment will be described with reference to FIG. 6. FIG. 6 is a block diagram showing an overall configuration of a posture estimation apparatus according to a second example embodiment.

The posture estimation apparatus 30 according to the second example embodiment shown in FIG. 6 is an apparatus that estimates the posture of a person in an image. As shown in FIG. 6, the posture estimation apparatus 30 includes a joint point detection unit 31, a reference point specifying unit 32, an attribution determination unit 33, and a posture estimation unit 34.

The joint point detection unit 31 detects joint points of a person in an image. The reference point specifying unit 32 specifies a preset reference point for each person in the image.

The attribution determination unit 33 uses the learning model to obtain a relationship between each joint point and the reference point of each person in the image for each joint point detected by the joint point detection unit 31. The learning model machine-learns the relationship between the pixel data and the unit vector for each pixel in the segmentation region of the person. Examples of the learning model used here include the learning model generated in the first example embodiment. The unit vector is a unit vector of a vector starting from each pixel and up to the reference point.

The attribution determination unit 33 calculates a score indicating the possibility that each joint point belongs to the person in the image based on the relationship obtained by using the learning model and determines the person in the image to which the joint point belongs by using the calculated score. The posture estimation unit 34 estimates the posture of the person in the image based on the result of determination by the attribution determination unit 33.

As described above, in the second example embodiment, for each joint point of the person in the image, an index (score) for determining whether or not the joint point of the person is the joint point is calculated. Therefore, it is possible to avoid a situation in which the joint point of that person is mistakenly included in the joint point of another person. Therefore, according to the embodiment, it is possible to improve the estimation accuracy when estimating the posture of a person from an image.

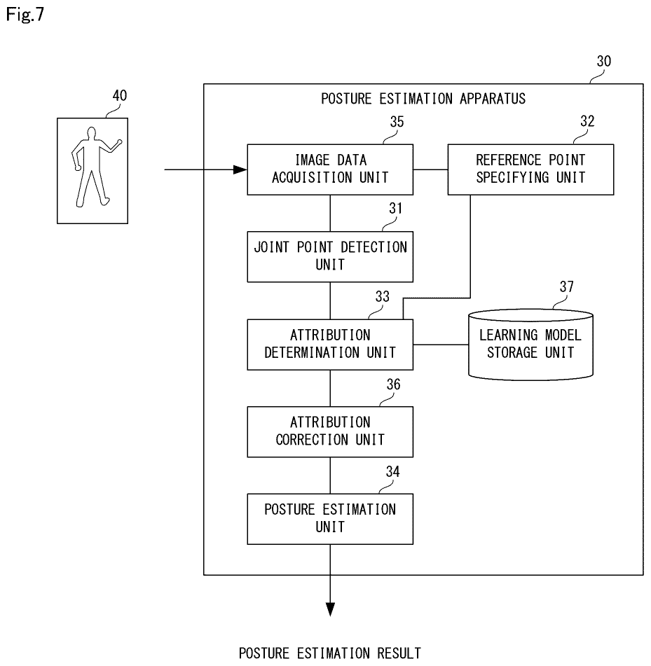

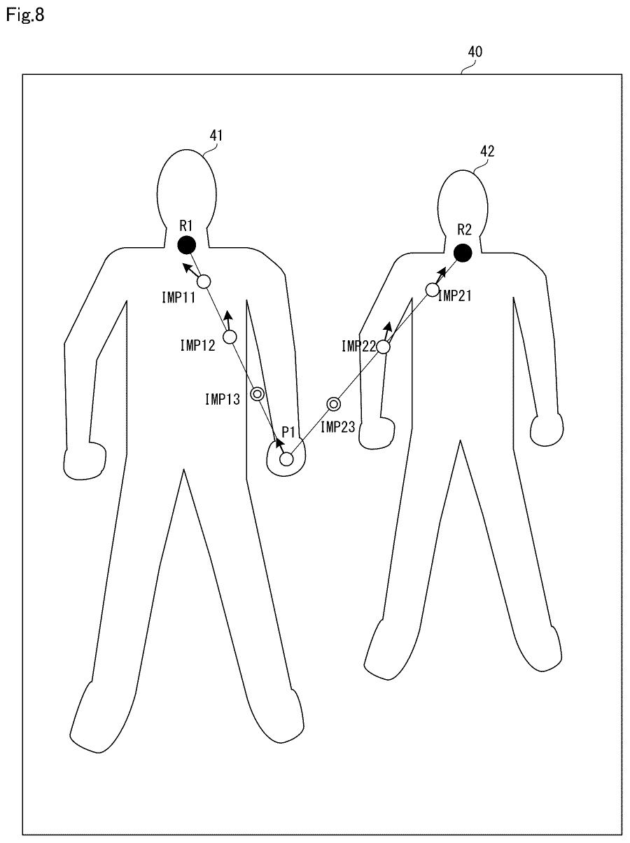

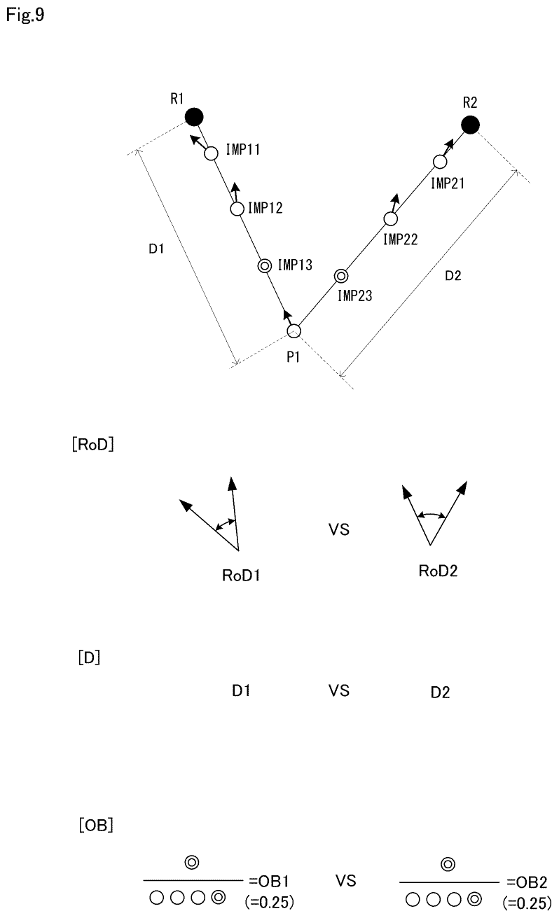

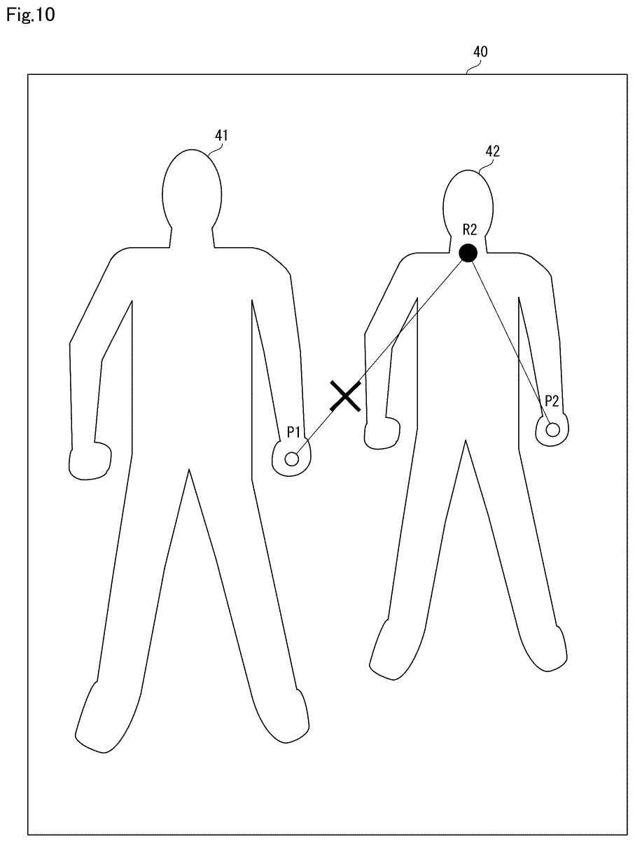

Subsequently, the configuration and function of the posture estimation apparatus 30 according to the second example embodiment will be specifically described with reference to FIGS. 7 to 10. FIG. 7 is a block diagram showing a specific configuration of the posture estimation apparatus according to the second example embodiment. FIG. 8 is a diagram illustrating the attribution determination process of the posture estimation apparatus according to the second example embodiment. FIG. 9 is a diagram illustrating a score calculated by the attribution determination process shown in FIG. 8. FIG. 10 is a diagram illustrating a correction process after the attribution determination of the posture estimation apparatus according to the second example embodiment.

As shown in FIG. 7, in the second example embodiment, the posture estimation apparatus 30 includes an image data acquisition unit 35, an attribution correction unit 36, and a learning model storage unit 37 in addition to the joint point detection unit 31, reference point specifying unit 32, attribution determination unit 33, and posture estimation unit 34.

The image data acquisition unit 35 acquires the image data 40 of the image of the person to be the posture estimation target and inputs the acquired image data to the joint point detection unit 31. Examples of the image data acquisition destination include an imaging device, a server device, a terminal device, and the like. The learning model storage unit 37 stores the learning model generated by the learning model generation apparatus 10 in the first example embodiment.

The joint point detection unit 31 detects the joint point of a person in the image from the image data input from the image data acquisition unit 35. Specifically, the joint point detection unit 31 detects each joint point of a person by using an image feature amount set in advance for each joint point. Further, the joint point detection unit 31 can also detect each joint point by using a learning model in which the image feature amount of the joint point of the person is machine-learned in advance. Examples of the joint points to be detected include the right shoulder, right elbow, right wrist, right hip joint, right knee, right ankle, left shoulder, left elbow, left wrist, left hip joint, left knee, and left ankle.

The reference point specifying unit 32 extracts a segmentation region of a person from the image data and sets a reference point on the extracted segmentation region. The position of the reference point is the same as the position of the reference point set at the time of generating the training data in the first example embodiment. When the reference point is set in the neck area in the training data, the reference point specifying unit 32 sets the reference point in the neck area on the segmentation region according to the rule used at the time of generating the training data.

In the second example embodiment, the attribution determination unit 33 obtains a direction variation (RoD: Range of Direction) for each joint point detected by the joint point detection unit 31 as a relationship between each joint point and a reference point of each person in the image. Specifically, the attribution determination unit 33 sets an intermediate point between the joint point and the reference point in the image for each reference point of the person in the image of the image data 40.

Then, the attribution determination unit 33 inputs the pixel data of the joint point, the pixel data of the intermediate point, and the coordinate data of each point into the learning model. Further, the attribution determination unit 33 obtains the unit vector of the vector from the joint point and the intermediate point to the reference point based on the output result of the learning model. Further, the attribution determination unit 33 obtains the direction variation ROD when the start points of the unit vectors obtained for the joint point and the intermediate point are aligned for each reference point of the person in the image. The attribution determination unit 33 calculates the score indicating the possibility that the joint point belongs to the person in the image based on the obtained direction variation RoD.

Further, the attribution determination unit 33 can also obtain the distance from the reference point to each joint point for each reference point of the person in the image for each detected joint point. In addition, the attribution determination unit 33 uses the output result of the learning model to identify the intermediate points that do not exist in the segmentation region of the person among the intermediate points. Then, the attribution determination unit 33 can also obtain the ratio of the intermediate points that do not exist in the segmentation region of the person for each reference point of the person in the image. Further, the attribution determination unit 33 can also calculate the score by using the direction variation ROD, the distance, and the ratio when the distance and the ratio are obtained.

Specifically, as shown in FIG. 8, it is assumed that the person 41 and the person 42 are present in the image. Then, it is assumed that the reference points R1 and R2 of each person are set in the respective neck areas. Further, in the example of FIG. 8, it is assumed that the joint point P1 is the score calculation target. In this case, the attribution determination unit 33 sets the intermediate points IMP11 to IMP13 between the joint point P1 and the reference point R1 in the person 41. The attribution determination unit 33 sets the intermediate points IMP21 to IMP23 between the joint point P1 and the reference point R2 in the person 42.

Next, the attribution determination unit 33 inputs the pixel data of the joint points P1, the pixel data of the intermediate points IMP11 to IMP13, the pixel data of the intermediate points IMP21 to IMP23, and the coordinate data of each point into the learning model. As a result, the unit vector of the vector from the joint point P1, the intermediate points IMP11 to IMP13, and the intermediate points IMP21 to IMP23 to the reference point starting from each are obtained. Each unit vector is indicated by an arrow in FIG. 8.

Subsequently, the attribution determination unit 33 identifies an intermediate point that does not exist in the segmentation region of the person, among the intermediate points IMP11 to IMP13 and intermediate points IMP21 to IMP23. Specifically, the attribution determination unit 33 inputs the x component and the y component of the unit vector to the following equation 1, and the intermediate point where the value is equal to or less than the threshold value does not exist in the segmentation region of the person.

(x component)²+(y component)²<Threshold Value (Equation 1)

In the example of FIG. 8, the attribution determination unit 33 determines that the intermediate point IMP13 and the intermediate point IMP23 do not exist in the segmentation region of the person. Further, in the example of FIG. 8, the intermediate points existing in the segmentation region of the person are represented by circles, and the intermediate points not existing in the segmentation region of the person are represented by double circles.

Subsequently, as shown in FIG. 9, the attribution determination unit 33 aligns the base points of the unit vectors of the intermediate points IMP11 and IPM12 (excluding IMP13) with the base point of the unit vector of the joint point P1. Then, the attribution determination unit 33 calculates a direction variation RoD 1. Similarly, the attribution determination unit 33 aligns the base point of the unit vector of the intermediate points IMP21 and IPM22 (excluding IMP23) with the base point of the unit vector of the joint point P1. The attribution determination unit 33 calculates a direction variation RoD 2. The direction variation is represented by the range of possible angles when the base points of the unit vectors are aligned.

Subsequently, as shown in FIG. 9, the attribution determination unit 33 calculates the distance D1 from the joint point P1 to the reference point R1 of the person 41 and the distance D2 from the joint point P1 to the reference point R2 of the person 42.

Further, as shown in FIG. 9, the attribution determination unit 33 calculates the ratio OB1 of the intermediate points that do not exist in the segmentation region of the person at the intermediate points IMP11 to IMP13 existing on the straight line from the joint point P1 to the reference point R1. The attribution determination unit 33 also calculates the ratio OB2 of the intermediate points that do not exist in the segmentation region of the person at the intermediate points IMP21 to IMP23 existing on the straight line from the joint point P1 to the reference point R2.

After that, the attribution determination unit 33 calculates the score for each reference point, that is, for each person. Specifically, the attribution determination unit 33 calculates RoD1*D1*OB1 for the person 41 and uses the calculated value as the score for the joint point P1 of the person 41. Similarly, the attribution determination unit 33 calculates RoD2*D2*OB2 for the person 42 and sets the obtained value as the score for the joint point P2 of the person 42.

In the examples of FIGS. 8 and 9, the score for the person 41 is smaller than the score for the person 42. Therefore, the attribution determination unit 33 determines the person to which the joint point P1 belongs as the person 41.

The attribution correction unit 36 compares the scores at each of the overlapping joint points when the overlapping joint points are included in the joint points determined to belong to the same person in the image. The attribution correction unit 36 determines that any of the overlapping joint points does not belong to the person based on the comparison result.

Specifically, for example, as shown in FIG. 10, it is assumed that two of the joint points P1 and P2 belong to the person 42. In this case, the person 42 includes two left wrists, which is unnatural. Therefore, the attribution correction unit 36 acquires the score calculated for the joint point P1 and the score calculated for the joint point P2 from the attribution determination unit 33, compares the two score. Then, the attribution correction unit 36 determines that the joint point having the larger score, that is, the joint point P1 in this case, does not belong to the person 42. As a result, the attribution of the joint points of the person is corrected.

In the second example embodiment, the posture estimation unit 34 specifies the coordinates of each joint point determined for each person based on the detection result by the joint point detection unit 31 and obtains the positional relationship between the joint points. Then, the posture estimation unit 34 estimates the posture of the person based on the obtained positional relationship.

Specifically, the posture estimation unit 34 compares the positional relationship registered in advance for each posture of the person with the obtained positional relationship, identifies the closest registered positional relationship. Then, the posture estimation unit 34 estimates the posture corresponding to the specified registered positional relationship as the posture of the person. Further, the posture estimation unit 34 can also inputs the obtained positional relationship into a learning model in which the relationship between the positional relationship and the coordinates of each joint is machine-learned in advance, the posture estimation unit 34 estimates the posture from the output result of this learning model.

### Apparatus Operations

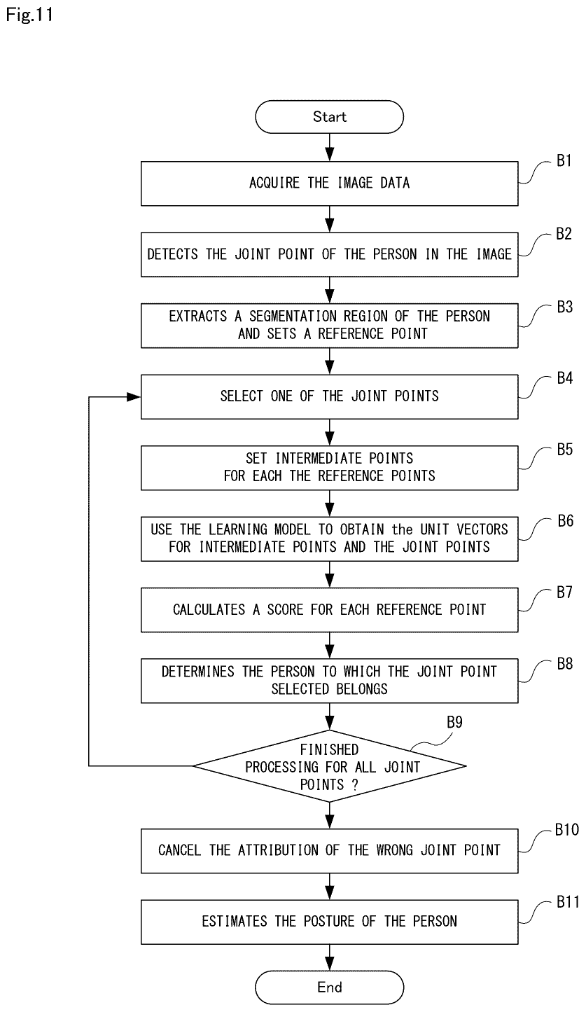

Next, operations of the posture estimation apparatus 30 according to the second example embodiment will be described with reference to FIG. 11. FIG. 11 is a flowchart showing operations of the posture estimation apparatus according to the second example embodiment. In the following description, FIGS. 6 to 10 are referenced when necessary. Also, in the second example embodiment, a posture estimation method is carried out by operating the posture estimation apparatus 30. Therefore, the following description of operations of the posture estimation apparatus 30 substitutes for a description of the posture estimation method in the second example embodiment.

As shown in FIG. 11, first, the image data acquisition unit 35 acquires the image data of the image of the person to be the posture estimation target (step B1).

Next, the joint point detection unit 31 detects the joint point of the person in the image from the image data acquired in step B1 (step B2).

Next, the reference point specifying unit 32 extracts a segmentation region of the person from the image data acquired in step B1 and sets a reference point on the extracted segmentation region (step B3).

Next, the attribution determination unit 33 selects one of the joint points detected in step B2 (step B4). Then, the attribution determination unit 33 sets an intermediate point between the selected joint point and the reference point (step B5).

Next, the attribution determination unit 33 inputs the pixel data of the selected joint point, the pixel data of each intermediate point, and the coordinate data of each point into the learning model and obtains the unit vector at each point (step B6).

Next, the attribution determination unit 33 calculates a score for each reference point set in step B3 using the unit vector obtained in step B6 (step B7).

Specifically, in step B7, the attribution determination unit 33 first identifies an intermediate point that does not exist in the segmentation region of the person by using the above-mentioned equation 1. Next, as shown in FIG. 9, the attribution determination unit 33 aligns, for a straight line from the joint point to the reference point, the base point of the unit vector of the intermediate point existing there with base point of the unit vector of the joint point to calculate the direction variation RoD.

Further, in step B7, as shown in FIG. 9, the attribution determination unit 33 calculates the distance D from the joint point to the reference point for each reference point. In addition, as shown in FIG. 9, the attribution determination unit 33 calculates the ratio of the intermediate points that do not exist in the segmentation region of the person, for each reference point. After that, the attribution determination unit 33 calculates the score of the selected joint point for each reference point by using the direction variation ROD, the distance D, and the ratio OB.

Next, the attribution determination unit 33 determines the person to which the joint point selected in step B4 belongs based on the score for each reference point calculated in step B7 (step B8).

Next, the attribution determination unit 33 determines whether or not the processes of steps B5 to B8 have been completed for all the joint points detected in step B2 (step B9).

As a result of the determination in step B9, if the processes of steps B5 to B8 have not been completed for all the joint points, the attribution determination unit 33 executes step B4 again to select the joint points that have not yet been selected.

On the other hand, as a result of the determination in step B9, if the process of steps B5 to B8 have been completed for all the joint points, the attribution determination unit 33 notifies the attribution correction unit 36 of that fact. The attribution correction unit 36 determines whether or not the overlapping joint points are included in the joint points determined to belong to the same person in the image. Then, when the overlapping joint points are included, the attribution correction unit 36 compares the scores at each of the overlapping joint points. Based on the comparison result, the attribution correction unit 36 determines that any of the overlapping joint points does not belong to the person and releases the attribution about it (step B10).

After that, the posture estimation unit 34 specifies the coordinates of each joint point determined to belong to the person for each person based on the detection result of the joint point in step B2 and obtains the positional relationship between the joint points. Further, the posture estimation unit 34 estimates the posture of the person based on the obtained positional relationship (step B11).

As described above, in the second example embodiment, the unit vector of the joint point of the person in the image is obtained by using the learning model generated in the first example embodiment. Then, the attribution of the detected joint point is accurately determined based on the obtained unit vector. Therefore, according to the second example embodiment, the estimation accuracy when estimating the posture of the person from the image can be improved.

### Program

A program for estimating the posture according to the second example embodiment may be a program that enables a computer to execute the steps B1 to B11 shown in FIG. 11. It is possible to realize the posture estimation apparatus 30 and the posture estimation method according to the second example embodiment by installing this program to a computer and executing the program. In this case, a processor of the computer functions as the joint point detection unit 31, the reference point specifying unit 32, the attribution determination unit 33, the posture estimation unit 34, the image data acquisition unit 35, and the attribution correction unit 36 and performs processing. Example of computer includes smartphone and tablet-type terminal device in addition to general-purpose personal computer.

Further, in the second example embodiment, the learning model storage unit 37 may be realized by storing the data files constituting them in a storage device such as a hard disk provided in the computer. And then, the learning model storage unit 37 may be realized by a storage device of another computer.

The program according to the second example embodiment may also be executed by a computer system built from a plurality of computers. In this case, for example, each computer may function as the joint point detection unit 31, the reference point specifying unit 32, the attribution determination unit 33, the posture estimation unit 34, the image data acquisition unit 35, and the attribution correction unit 36.

### (Physical Configuration)

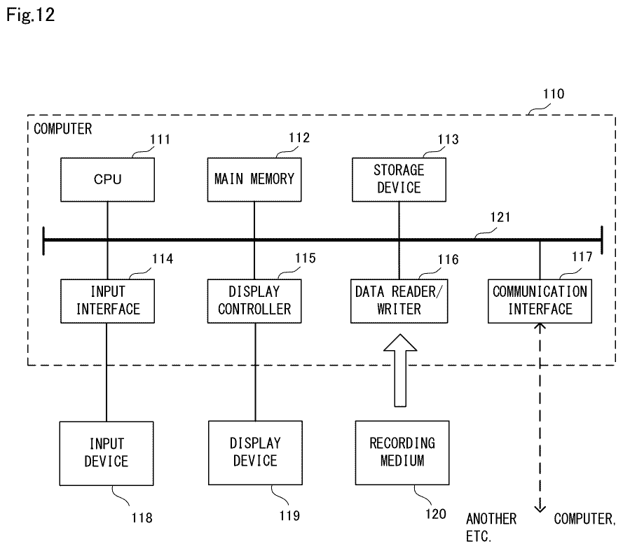

Hereinafter, a computer that realizes learning model generation apparatus 10 according to the first example embodiments by executing the program according to the first example embodiments, and a computer that realizes the posture estimation apparatus 30 according to the second example embodiments by executing the program according to the second example embodiments will be described with reference to FIG. 12. FIG. 12 is a block diagram showing an example of a computer that realizes the learning model generation apparatus according to the first example embodiment and the posture estimation apparatus according to the second example embodiment.

As shown in FIG. 12, a computer 101 includes a CPU 111, a main memory 112, a storage device 113, an input interface 114, a display controller 115, a data reader/writer 116, and a communication interface 117. These units are connected so as to be able to perform data communication with each other via a bus 121. The computer 110 may include a GPU (Graphics Processing Unit) or an FPGA (Field-Programmable Gate Array) in addition to the CPU 111 or instead of the CPU 111.

The CPU 11 loads the program composed of codes stored in the storage device 113 to the main memory 112 and execute each code in a predetermined order to perform various kinds of computations. The main memory 112 is typically a volatile storage device such as a DRAM (Dynamic Random-Access Memory).

The program according to the first and second example embodiments is provided in the state of being stored in a computer-readable recording medium 120. Note that the program according to the first and second example embodiments may be distributed on the internet connected via a communication interface 117.

Specific examples of the storage device 113 include a hard disk drive, and a semiconductor storage device such as a flash memory. The input interface 114 mediates data transmission between the CPU 111 and input devices 118 such as a keyboard and a mouse. The display controller 115 is connected to a display device 119, and controls display on the display device 119.

The data reader/writer 116 mediates data transmission between the CPU 111 and a recording medium 120, reads the program from the recording medium 120, and writes the result of processing in the computer 110 to the recording medium 120. The communication interface 117 mediates data transmission between the CPU 111 and another computer.

Specific examples of the recording medium 120 include general-purpose semiconductor storage devices such as a CF (Compact Flash (registered trademark)) and an SD (Secure Digital), magnetic recording media such as a Flexible Disk, and optical recording media such as a CD-ROM (Compact Disk Read Only Memory).

Note that the learning model generation apparatus 10 according to the first example embodiment and the posture estimation apparatus 30 according to the second example embodiment can be realized using hardware corresponding to the respective units thereof instead of a computer to which a program is installed. Furthermore, part of the learning model generation apparatus 10 and part of the posture estimation apparatus 30 may be realized using a program, and the rest may be realized using hardware. The hardware here includes an electronic circuit.

One or more or all of the above-described example embodiments can be represented by the following (Supplementary note 1) to (Supplementary note 18), but are not limited to the following description.

### (Supplementary Note 1)

A posture estimation apparatus comprising:
a joint point detection unit configured to detect joint points of a person in an image, a reference point specifying unit configured to specify a preset reference point for each person in the image,
an attribution determination unit configured to use a learning model that machine-learns the relationship between a pixel data and the unit vector of the vector starting from a pixel to the reference point for each pixel in the segmentation region of the person, to obtain a relationship between the detected joint points and the reference point of the each person in the image for each detected joint point, and then to calculate a score indicating the possibility that the joint point belongs to the person in the image based on the obtained relationship, to determine the person in the image to which the joint point belongs by using the calculated score,
a posture estimation unit configured to estimate the posture of the person in the image based on the result of determination by the attribution determination unit.

### (Supplementary Note 2)

The posture estimation apparatus according to Supplementary note 1,
wherein the attribution determination unit, for each of the detected joint points, sets an intermediate point between the joint point and the reference point in the image for each of the reference points of the person in the image, and input the pixel data of the joint point and the pixel data of the intermediate point to the learning model, and obtain the unit vector of a vector starting from the joint point and the intermediate point to the reference point for each point, using the output result of the learning model,
   further, for each of the reference points of the person in the image, obtain the variation in the direction when the start points of the unit vector obtained at the joint point and the intermediate point are aligned, and calculates the score based on the obtained variation.

### (Supplementary Note 3)

The posture estimation apparatus according to Supplementary note 2,
wherein the attribution determination unit further obtains the distance to the joint point for each of the detected reference points of the person in the image for each of the detected joint points, uses the output result of the learning model to identify an intermediate point among the intermediate points that does not exist in the segmentation region of the person, calculates the ratio of intermediate points that do not exist in the sectioning region of the person for each reference point of the person in the image, and calculates the score by using the variation, the distance, and the ratio.

### (Supplementary Note 4)

The posture estimation apparatus according to any of Supplementary notes 1 to 3, further comprising:

An attribution correction unit that compares the scores at each of the overlapping joint points when the overlapping joint points are included in the joint points determined to belong to the same person in the image and determines that one of the overlapping joint points does not belong to the person based on the comparison result.

### (Supplementary Note 5)

The posture estimation apparatus according to any of Supplementary notes 1 to 4,
wherein the reference point is set in the trunk region or neck region of the person in the image.

### (Supplementary Note 6)

A learning model generation apparatus comprising:
a learning model generation unit configured to use pixel data for each pixel of the segmentation region of a person, coordinates date for each pixel of the segmentation region, and a unit vector of the vector starting from a pixel to a preset reference point for each pixel of the segmentation region as training data, to perform machine learning to generate a learning model.

### (Supplementary Note 7)

A posture estimation method comprising:
a joint point detection step of detecting joint points of a person in an image,
a reference point specifying step of specifying a preset reference point for each person in the image,
an attribution determination step of using a learning model that machine-learns the relationship between a pixel data and the unit vector of the vector starting from a pixel to the reference point for each pixel in the segmentation region of the person, to obtain a relationship between the detected joint points and the reference point of the each person in the image for each detected joint point, and then calculating a score indicating the possibility that the joint point belongs to the person in the image based on the obtained relationship, determining the person in the image to which the joint point belongs by using the calculated score,
a posture estimation step of estimating the posture of the person in the image based on the result of determination by the attribution determination step.

### (Supplementary Note 8)

The posture estimation method according to Supplementary note 7,
wherein, in the attribution determination step, for each of the detected joint points, setting an intermediate point between the joint point and the reference point in the image for each of the reference points of the person in the image, and inputting the pixel data of the joint point and the pixel data of the intermediate point to the learning model, and obtaining the unit vector of a vector starting from the joint point and the intermediate point to the reference point for each point, using the output result of the learning model,
   further, for each of the reference points of the person in the image, obtaining the variation in the direction when the start points of the unit vector obtained at the joint point and the intermediate point are aligned, and calculating the score based on the obtained variation.

### (Supplementary Note 9)

The posture estimation method according to Supplementary note 8,
wherein, in the attribution determination step, further obtaining the distance to the joint point for each of the detected reference points of the person in the image for each of the detected joint points, using the output result of the learning model to identify an intermediate point among the intermediate points that does not exist in the segmentation region of the person, calculating the ratio of intermediate points that do not exist in the sectioning region of the person for each reference point of the person in the image, and calculating the score by using the variation, the distance, and the ratio.

### (Supplementary Note 10)

The posture estimation method according to any of Supplementary notes 7 to 9, further comprising:
an attribution correction step of comparing the scores at each of the overlapping joint points when the overlapping joint points are included in the joint points determined to belong to the same person in the image and determining that one of the overlapping joint points does not belong to the person based on the comparison result.

### (Supplementary Note 11)

The posture estimation method according to any of Supplementary notes 7 to 10,
wherein the reference point is set in the trunk region or neck region of the person in the image.

### (Supplementary Note 12)

A learning model generation method comprising:
a learning model generation step of using pixel data for each pixel of the segmentation region of a person, coordinates date for each pixel of the segmentation region, and a unit vector of the vector starting from a pixel to a preset reference point for each pixel of the segmentation region as training data, to perform machine learning to generate a learning model.

### (Supplementary Note 13)

A computer-readable recording medium that includes a program, the program including instructions that cause the computer to carry out:
a joint point detection step of detecting joint points of a person in an image,
a reference point specifying step of specifying a preset reference point for each person in the image,
an attribution determination step of using a learning model that machine-learns the relationship between a pixel data and the unit vector of the vector starting from a pixel to the reference point for each pixel in the segmentation region of the person, to obtain a relationship between the detected joint points and the reference point of the each person in the image for each detected joint point, and then calculating a score indicating the possibility that the joint point belongs to the person in the image based on the obtained relationship, determining the person in the image to which the joint point belongs by using the calculated score,
a posture estimation step of estimating the posture of the person in the image based on the result of determination by the attribution determination step.

### (Supplementary Note 14)

The computer-readable recording medium according to Supplementary note 13,
wherein, in the attribution determination step, for each of the detected joint points, setting an intermediate point between the joint point and the reference point in the image for each of the reference points of the person in the image, and inputting the pixel data of the joint point and the pixel data of the intermediate point to the learning model, and obtaining the unit vector of a vector starting from the joint point and the intermediate point to the reference point for each point, using the output result of the learning model,
   further, for each of the reference points of the person in the image, obtaining the variation in the direction when the start points of the unit vector obtained at the joint point and the intermediate point are aligned, and calculating the score based on the obtained variation.

### (Supplementary Note 15)

The computer-readable recording medium according to Supplementary note 14,
wherein, in the attribution determination step, further obtaining the distance to the joint point for each of the detected reference points of the person in the image for each of the detected joint points, using the output result of the learning model to identify an intermediate point among the intermediate points that does not exist in the segmentation region of the person, calculating the ratio of intermediate points that do not exist in the sectioning region of the person for each reference point of the person in the image, and calculating the score by using the variation, the distance, and the ratio.

### (Supplementary Note 16)

The computer-readable recording medium according to any of Supplementary notes 13 to 15, the program further including instruction that cause the computer to carry out:
an attribution correction step of comparing the scores at each of the overlapping joint points when the overlapping joint points are included in the joint points determined to belong to the same person in the image and determining that one of the overlapping joint points does not belong to the person based on the comparison result.

### (Supplementary Note 17)

The computer-readable recording medium according to any of Supplementary notes 13 to 16,
wherein the reference point is set in the trunk region or neck region of the person in the image.

### (Supplementary Note 18)

A computer-readable recording medium that includes a program, the program including instructions that cause the computer to carry out:
a learning model generation step of using pixel data for each pixel of the segmentation region of a person, coordinates date for each pixel of the segmentation region, and a unit vector of the vector starting from a pixel to a preset reference point for each pixel of the segmentation region as training data, to perform machine learning to generate a learning model.

While the invention has been described with reference to the example embodiment, the invention is not limited to the example embodiments described above. Various modifications that can be understood by a person skilled in the art may be applied to the configuration and the details of the present invention within the scope of the present invention.

### INDUSTRIAL APPLICABILITY

As described above, according to the present invention, it is possible to improve the estimation accuracy when estimating the posture of a person from an image. The present invention is useful in fields where it is required to estimate the posture of a person from an image, for example, in the field of image surveillance and the field of sports.

### REFERENCE SIGNS LIST

10 Learning model generation apparatus
11 Learning model generation unit
12 Training data acquisition unit
13 Training data storage unit
20 Image data
21 Human (Segmentation region)
22 Reference point
30 Posture estimation apparatus
31 Joint point detection unit
32 Reference point specifying unit
33 Attribution determination unit
34 Posture estimation unit
35 Image data acquisition unit
36 Attribution correction unit
37 Learning model storage unit
40 Image data
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. A posture estimation apparatus comprising:
at least one memory storing instructions; and
at least one processor configured to execute the instructions to:
detect joint points of a person in an image,
specify a preset reference point for each person in the image,
use a learning model that machine-learns the relationship between a pixel data and the unit vector of the vector starting from a pixel to the reference point for each pixel in the segmentation region of the person, to obtain a relationship between the detected joint points and the reference point of the each person in the image for each detected joint point, and then calculate a score indicating the possibility that the joint point belongs to the person in the image based on the obtained relationship, determine the person in the image to which the joint point belongs by using the calculated score,
estimate the posture of the person in the image based on the result of determination determination.

2. The posture estimation apparatus according to claim 1,
further at least one processor configured to execute the instructions to:
for each of the detected joint points, set an intermediate point between the joint point and the reference point in the image for each of the reference points of the person in the image, and input the pixel data of the joint point and the pixel data of the intermediate point to the learning model, and obtain the unit vector of a vector starting from the joint point and the intermediate point to the reference point for each point, using the output result of the learning model,
further, for each of the reference points of the person in the image, obtain the variation in the direction when the start points of the unit vector obtained at the joint point and the intermediate point are aligned, and calculates the score based on the obtained variation.

3. The posture estimation apparatus according to claim 2,
further at least one processor configured to execute the instructions to:
obtain the distance to the joint point for each of the detected reference points of the person in the image for each of the detected joint points, use the output result of the learning model to identify an intermediate point among the intermediate points that does not exist in the segmentation region of the person, calculate the ratio of intermediate points that do not exist in the sectioning region of the person for each reference point of the person in the image, and calculate the score by using the variation, the distance, and the ratio.

4. The posture estimation apparatus according to claim 1,
further at least one processor configured to execute the instructions to:
compare the scores at each of the overlapping joint points when the overlapping joint points are included in the joint points determined to belong to the same person in the image and determine that one of the overlapping joint points does not belong to the person based on the comparison result.

5. The posture estimation apparatus according to claim 1,
wherein the reference point is set in the trunk region or neck region of the person in the image.

6. (canceled)

7. A posture estimation method comprising:
a detecting joint points of a person in an image,
a specifying a preset reference point for each person in the image,
an using a learning model that machine-learns the relationship between a pixel data and the unit vector of the vector starting from a pixel to the reference point for each pixel in the segmentation region of the person, to obtain a relationship between the detected joint points and the reference point of the each person in the image for each detected joint point, and then calculating a score indicating the possibility that the joint point belongs to the person in the image based on the obtained relationship, determining the person in the image to which the joint point belongs by using the calculated score,
an estimating the posture of the person in the image based on the result of determination by the attribution determination means.

8. The posture estimation method according to claim 7,
wherein, in the determination, for each of the detected joint points, setting an intermediate point between the joint point and the reference point in the image for each of the reference points of the person in the image, and inputting the pixel data of the joint point and the pixel data of the intermediate point to the learning model, and obtaining the unit vector of a vector starting from the joint point and the intermediate point to the reference point for each point, using the output result of the learning model,
further, for each of the reference points of the person in the image, obtaining the variation in the direction when the start points of the unit vector obtained at the joint point and the intermediate point are aligned, and calculating the score based on the obtained variation.

9. The posture estimation method according to claim 8,
wherein, in the determination, further obtaining the distance to the joint point for each of the detected reference points of the person in the image for each of the detected joint points, using the output result of the learning model to identify an intermediate point among the intermediate points that does not exist in the segmentation region of the person, calculating the ratio of intermediate points that do not exist in the sectioning region of the person for each reference point of the person in the image, and calculating the score by using the variation, the distance, and the ratio.

10. The posture estimation method according to claim 7, further comprising:
a comparing the scores at each of the overlapping joint points when the overlapping joint points are included in the joint points determined to belong to the same person in the image and determining that one of the overlapping joint points does not belong to the person based on the comparison result.

11. The posture estimation method according to claim 7,
wherein the reference point is set in the trunk region or neck region of the person in the image.

12. (canceled)

13. A non-transitory computer-readable recording medium that includes a program, the program including instructions that cause the computer to carry out:
a detecting joint points of a person in an image,
a specifying a preset reference point for each person in the image,
an using a learning model that machine-learns the relationship between a pixel data and the unit vector of the vector starting from a pixel to the reference point for each pixel in the segmentation region of the person, to obtain a relationship between the detected joint points and the reference point of the each person in the image for each detected joint point, and then calculating a score indicating the possibility that the joint point belongs to the person in the image based on the obtained relationship, determining the person in the image to which the joint point belongs by using the calculated score,
an estimating the posture of the person in the image based on the result of determination by the attribution determination means.

14. The non-transitory computer-readable recording medium according to claim 13,
wherein, in the determination, for each of the detected joint points, setting an intermediate point between the joint point and the reference point in the image for each of the reference points of the person in the image, and inputting the pixel data of the joint point and the pixel data of the intermediate point to the learning model, and obtaining the unit vector of a vector starting from the joint point and the intermediate point to the reference point for each point, using the output result of the learning model,
further, for each of the reference points of the person in the image, obtaining the variation in the direction when the start points of the unit vector obtained at the joint point and the intermediate point are aligned, and calculating the score based on the obtained variation.

15. The non-transitory computer-readable recording medium according to claim 14,
wherein, in the determination, further obtaining the distance to the joint point for each of the detected reference points of the person in the image for each of the detected joint points, using the output result of the learning model to identify an intermediate point among the intermediate points that does not exist in the segmentation region of the person, calculating the ratio of intermediate points that do not exist in the sectioning region of the person for each reference point of the person in the image, and calculating the score by using the variation, the distance, and the ratio.

16. The non-transitory computer-readable recording medium according to claim 13, the program further including instruction that cause the computer to carry out:
a comparing the scores at each of the overlapping joint points when the overlapping joint points are included in the joint points determined to belong to the same person in the image and determining that one of the overlapping joint points does not belong to the person based on the comparison result.

17. The non-transitory computer-readable recording medium according to claim 13,
wherein the reference point is set in the trunk region or neck region of the person in the image.

18. (canceled)
